(19) United States
(12) Patent Application Publication
(10) Pub. No.: US 2019/0088160 A1
(43) Pub. Date: Mar. 21, 2019

(54) DANCE TRAINING DEVICE

(71) Applicant: Jian LIU, Lianyungang (CN)

(72) Inventors: Jian LIU, Lianyungang (CN); Suwen LIU, Lianyungang (CN)

(21) Appl. No.: 16/162,361

(22) Filed: Oct. 16, 2018

Related U.S. Application Data
(63) Continuation-in-part of application No. PCT/CN2018/073398, filed on Jan. 19, 2018.

(30) Foreign Application Priority Data
Sep. 18, 2017 (CN) 201710838175.3
Dec. 18, 2017 (CN) 201711365990.9

(51) Int. Cl. G09B 19/00; A63B 23/02

(52) U.S. Cl. CPC G09B 19/0015; A63B 2208/02; A63B 23/0244

(57) ABSTRACT

A dance training device, including: a training unit; a measuring unit; and a connection rod. The training unit is connected to the measuring unit via the connection rod. The training unit includes a base, an elastic balancing plate, and a self-balancing airbag disposed between the elastic balancing plate and the base. The base includes an upper surface and a balancing trough disposed on the upper surface. The self-balancing airbag is located in the balancing trough. The measuring unit includes a first support frame, a second support frame, a third support frame, self-balancing universal wheel assemblies, and an angle measurement instrument. The second support frame and the third support frame are vertically disposed relative to the ground, and each includes a first end and a second end. Two ends of the first support frame are joined to the first ends of the second support frame and the third support frame, respectively.

### CROSS-REFERENCE TO RELATED APPLICATIONS

This application is a continuation-in-part of International Patent Application No. PCT/CN2018/073398 with an international filing date of Jan. 19, 2018, designating the United States, now pending, and further claims foreign priority benefits to Chinese Patent Application No. 201710838175.3 filed Sep. 18, 2017, and to Chinese Patent Application No. 201711365990.9 filed Dec. 18, 2017. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, Mass. 02142.

### BACKGROUND

Conventional dance training devices are limited in their function. If the trainees have developed poor training postures and habits, the poor training postures and habits are not detected by the training devices. In addition, conventional dance training devices have rigid structures, and are not adjustable to the trainees' physical characteristics. This adversely affects the trainees' experience.

### SUMMARY

Disclosed is a dance training device that can sense and measure the body angles of the trainees during dancing, and therefore, overcomes many of the above-mentioned problems.

In particular, disclosed is a dance training device, comprising: a training unit; a measuring unit; and a connection rod. The training unit is connected to the measuring unit via the connection rod; the training unit comprises a base, an elastic balancing plate, and a self-balancing airbag disposed between the elastic balancing plate and the base; one end of the base is connected to one end of the elastic balancing plate using a rotary joint; the base comprises an upper surface and a balancing trough disposed on the upper surface, and the self-balancing airbag is located in the balancing trough; the measuring unit comprises a first support frame, a second support frame, a third support frame, self-balancing universal wheel assemblies, and an angle measurement instrument; the second support frame and the third support frame are vertically disposed relative to the ground, and each comprises a first end and a second end; two ends of the first support frame are joined to the first ends of the second support frame and the third support frame, respectively, and the self-balancing universal wheel assemblies are disposed on the second ends of the second support frame and the third support frame, respectively; the angle measurement instrument is rotatably disposed on the first support frame; and the first support frame, the second support frame, and the third support frame each are provided with a scale, and the second support frame and the third support frame each comprise a top surface and a bubble level disposed on the top surface.

The training unit can further comprise a support roller which is adapted to roll on the elastic balancing plate; two ends of the support roller can be provided with support mechanisms and rolling wheels, respectively, and the rolling wheels can be respectively disposed in the support mechanisms; two sides of the elastic balancing plate can be provided with sliding rails, and the rolling wheels can be adapted to roll on the sliding rails.

The rolling wheels can employ three mutually meshed gears, and one of the three mutually meshed gears can be provided with a control handwheel.

Two self-balancing airbags and four balancing troughs can be employed; every two balancing troughs can be arranged side by side, and can be adapted to accommodate one of the two self-balancing airbags.

The training unit can comprise a placement plate; the placement plate can be disposed at one side of the balancing trough and can comprise an auxiliary groove and a fastener adapted to fasten the balancing trough and the placement plate, and the self-balancing airbag can be located in the balancing trough and the auxiliary groove of the placement plate.

The base can be connected to the elastic balancing plate through a rotary mechanism; the rotary mechanism can comprise a rotating shaft and shaft seats; the rotating shaft can run through the one end of the elastic balancing plate; the shaft seats can be fixed on the base, and two ends of the rotating shaft can be supported by the shaft seats.

The elastic balancing plate can comprise an outer surface and a recess formed on the outer surface; and a buffer cushion can be disposed in the recess.

The elastic balancing plate can be arc-shaped.

The second support frame and the third support frame can be telescopic.

The second support frame and the third support frame each comprise a sleeve plate and a liner plate; the second support frame and the third support frame can be connected to the first support frame via sleeve plates; one end of the liner plate can be inserted in the sleeve plate, and the other end of the liner plate can be connected to one of the self-balancing universal wheel assemblies.

The sleeve plate can comprise a lateral sliding gear, and the liner plate can comprise a lateral sliding groove corresponding to the lateral sliding gear; and the lateral sliding gear can be provided with a control handwheel.

The sleeve plates of the second support frame and the third support frame can be provided with spring pins, and the two ends of the first support frame can be joined to the second support frame and the third support frame via the spring pins of the sleeve plates, respectively.

The self-balancing universal wheel assemblies each can comprise a transverse connecting shaft and two universal wheelsets disposed on the transverse connecting shaft; each universal wheelset can comprise four roller wheels connected to the transverse connecting shaft through a connecting rod; the four roller wheels can be connected to four corners of the connecting rod through two longitudinal connecting shafts; the transverse connecting shaft can comprise a limiting block, the connecting rod can comprise a limiting groove corresponding to the limiting block, and the connecting rod can be mounted on the transverse connecting shaft via the limiting groove and the limiting block; the two longitudinal connecting shafts each comprise a swinging groove, the connecting rod can comprise a swing block corresponding to the swing groove, and the two longitudinal connecting shafts can be mounted on the connecting rod via the swing block and the swing groove.

The angle measurement instrument can be an induction display connected to a microcomputer.

The induction display can comprise a host, a display screen, a lithium battery, and a charger; and the host can comprise a sensor which is of a polycrystalline structure.

A plurality of support pads can be distributed on the bottom surface of the base.

Advantages of the dance training device as descried in the disclosure are summarized as follows.

1. One of more self-balancing airbags provide sufficient buffer for the training, and a plurality of support pads is distributed on the bottom surface of the base, so the training unit is safe.

2. The self-balancing universal wheel assemblies can move freely, the second support frame and the third support frame are telescopic relative to the ground and can move along the first support frame, so the dance training device can comprehensively measure the body angles during the dancing, which is helpful to correct poor postures.

3. The dance training device is multifunctional and can bring the trainees with good user experience.

### BRIEF DESCRIPTION OF THE DRAWINGS

FIG. 1 is a schematic diagram of a dance training and measuring device as described in the disclosure;

FIG. 2 is a schematic diagram of a training unit of a dance training device as described in the disclosure;

FIG. 3 is a schematic diagram of a training unit having one self-balancing airbag as described in the disclosure;

FIG. 4 is a schematic diagram of a training unit having two self-balancing airbags as described in the disclosure;

FIG. 5 is schematic diagram of a measuring unit of a dance training device as described in the disclosure;

FIG. 6 is a side view of a measuring unit of a dance training device as described in the disclosure;

FIG. 7 is a side view of a measuring unit of a dance training device as described in the disclosure in a use state; and

FIG. 8 is a side view of a measuring unit of a dance training device as described in the disclosure in a folded state.

### DETAILED DESCRIPTION

To further illustrate, embodiments detailing a dance training device are described below. It should be noted that the following embodiments are intended to describe and not to limit the disclosure.

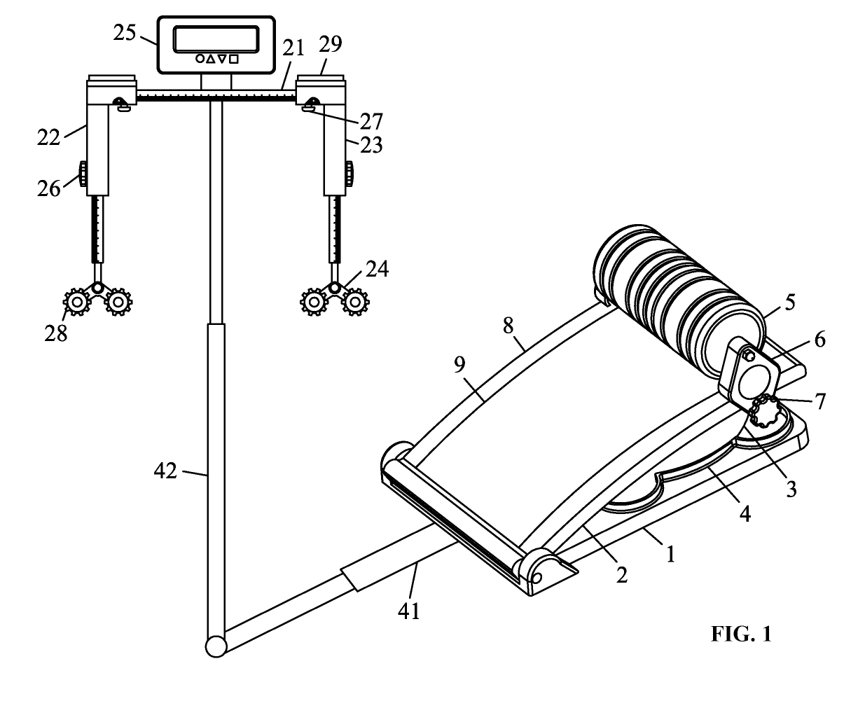

Referring to FIG. 1, a dance training device is provided, comprising a training unit, a measuring unit, and a connection rod. The training unit is connected to the measuring unit via the connection rod. The connection rod comprises a transverse connection rod 41 connected to the measuring unit and a vertical connection rod 42 connected to the training unit.

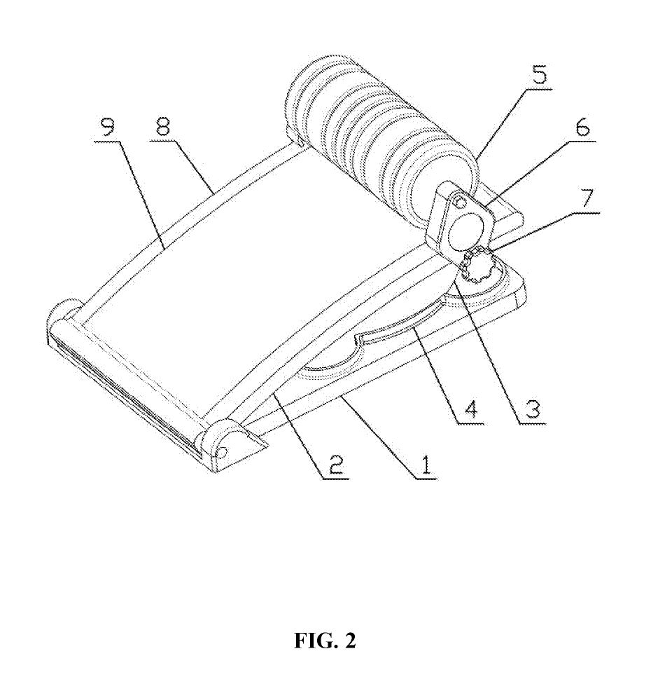

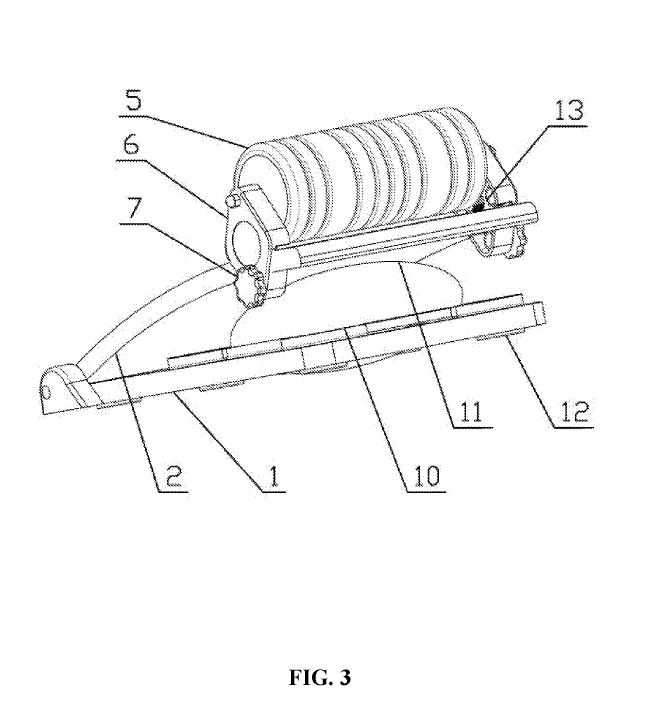

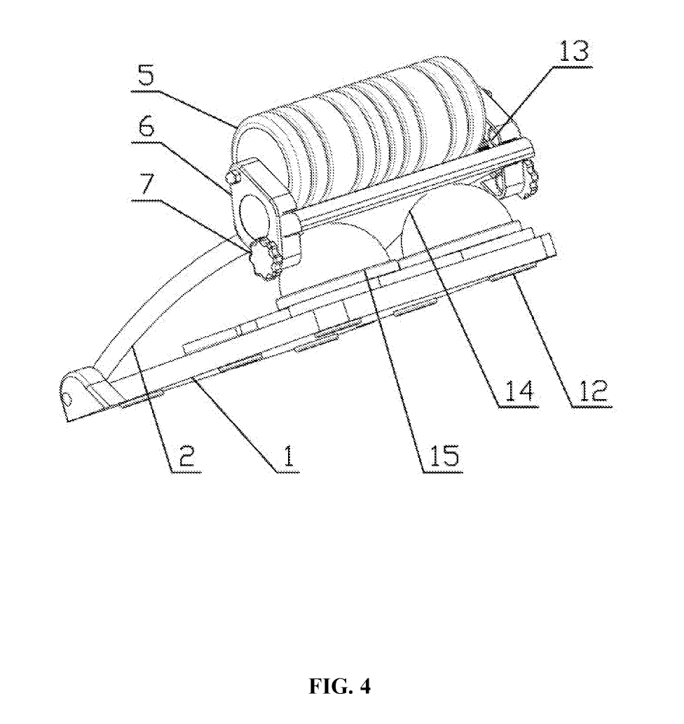

As shown in FIGS. 2, 3, and 4, the training unit comprises a base 1, an elastic balancing plate 2, and self-balancing airbag 3. The elastic balancing plate 2 is used for somersault training of the trainers. One end of the elastic balancing plate 2 is in rotary connection to one end of the base 1. The self-balancing airbag 3 is used for providing buffer action during the somersault training, and is disposed between the elastic balancing plate 2 and the base 1. A balancing trough 4 is formed on the base 1 for accommodating the self-balancing airbag 3. The training unit further comprises a support roller 5 for somersault and warm-up exercise.

Two ends of the support roller are provided with support mechanisms 6, respectively; the support mechanisms 6 are provided with rolling wheels 13, two sides of the elastic balancing plate 2 are provided with sliding rails 8, and the rolling wheels 13 are adapted to roll on the sliding rails 8. Two ends of the support roller 5 are mounted on the elastic balancing plate 2 through the support mechanisms 6. The base 1 is arranged on the ground to play the role of fixation. The self-balancing airbag 3 is arranged between the elastic balancing plate 2 and the base 1. The arrangement of the balancing trough 4 is convenient for the placement of the self-balancing airbag 3, thereby preventing the self-balancing airbag 3 from deviating when being pressed. The support roller 5 can move on the sliding rails 8 via the rolling wheels 13 to adjust its position on the elastic balancing plate 2. This facilitates the warm-up of trainees before somersault training, by which the shoulders, the waist, the legs and the crotch are all stretched to avoid any injury to the body. The support roller 5 may be removed from the elastic balancing plate 2 during somersault training, and mounted on the elastic balancing plate 2 before next use. Moreover, the air pressure in the self-balancing airbag 3 may be adjusted according to actual requirements, to adjust the buffer force. Furthermore, since the cushioning action provided by the self-balancing airbag 3 is soft buffering, the ankles of trainees can be effectively protected. The self-balancing airbag 3 may be replaced with any other elastic elements, for example, springs.

One self-balancing airbag 3 and one balancing trough 4 can be provided. The arrangement of one self-balancing airbag 3 ensures high elasticity. Optionally, two self-balancing airbags 3 and four balancing troughs 4 can be provided. The four balancing troughs 4 are provided on the top of the base 1 in two parallel rows. The placement positions of the two self-balancing airbags 3 may be determined according to actual requirements. The arrangement of two self-balancing airbags 3 ensures high stability.

The training unit further comprises a placement plate 15; the placement plate is disposed at one side of the balancing trough and comprises an auxiliary groove and a fastener adapted to fasten the balancing trough and the placement plate, and the self-balancing airbag 3 is located in the balancing trough and the auxiliary groove of the placement plate.

The sliding rails 8 are gear rails and the rolling wheels 13 are gears. The rolling wheels employ three mutually meshed gears, and one of the three mutually meshed gears is provided with a control handwheel 7. The support roller 5 is mounted on the elastic balancing plate 2 by the engagement of the gears with the gear rails. After the support roller 5 moves to a desired position, it is locked by the control handwheel 7. This facilitates the actual stretching operation.

The elastic balancing plate 2 is in rotary connection to the base 1 by a rotating mechanism. The rotating mechanism comprises a rotating shaft and a rotating shaft seat. The rotating shaft runs through one end of the elastic balancing plate 2. The rotating shaft seat is fixed on the base 1. Two ends of the rotating shaft are mounted on the rotating shaft seat. The elastic balancing plate 2 can rotate about the base 1. This is convenient for the placement of the self-balancing airbag 3.

The elastic balancing plate 2 comprises an outer surface and a recess formed on the outer surface; and a buffer cushion 9 is disposed in the recess. The arrangement of the buffer cushion 9 increases the friction at the moment of bouncing for a somersault. In addition, such an arrangement increases the assistance, and avoids the slippage at the moment of bouncing.

A plurality of support pads 12 are distributed on the bottom of the base 1. The support pads 12 can increase the friction force of the training unit with the ground, and support and protect the base 1.

The elastic balancing plate 2 is arc-shaped. Such a design facilitates the fitting of the elastic balancing plate 2 with the self-balancing airbag 3.

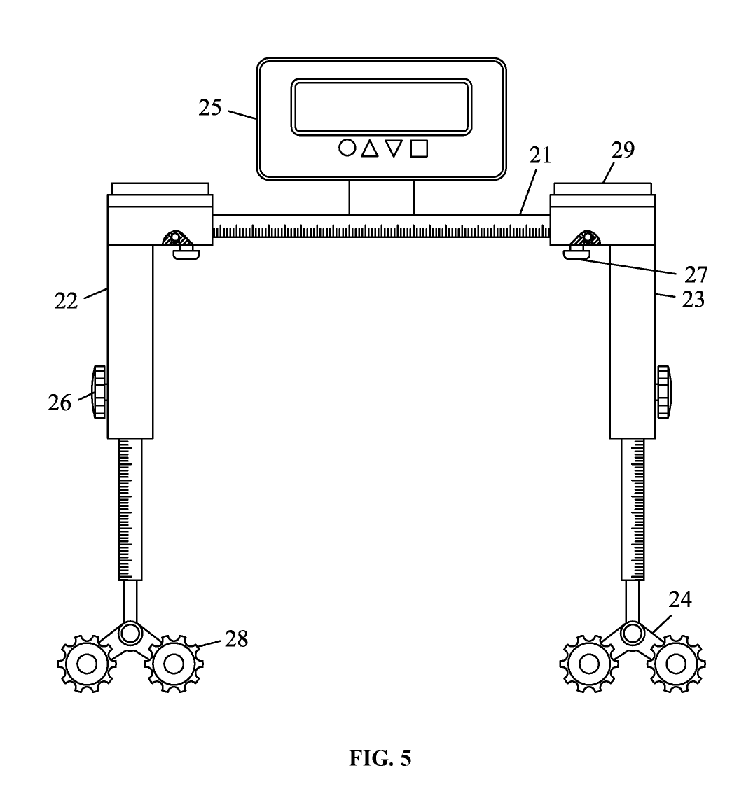

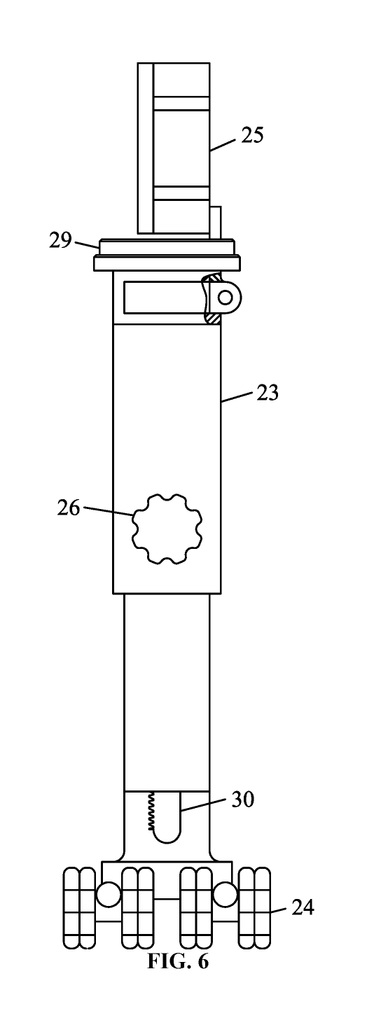

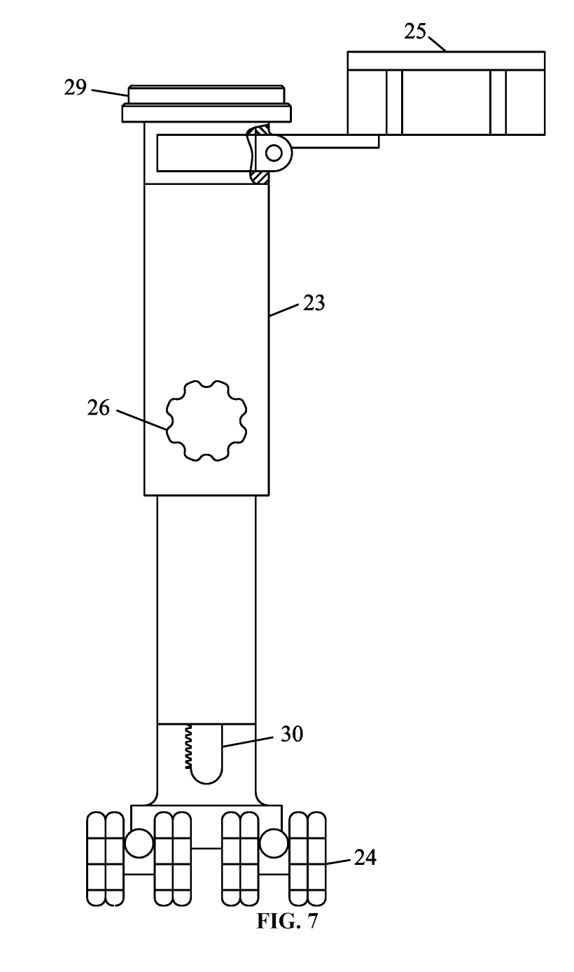

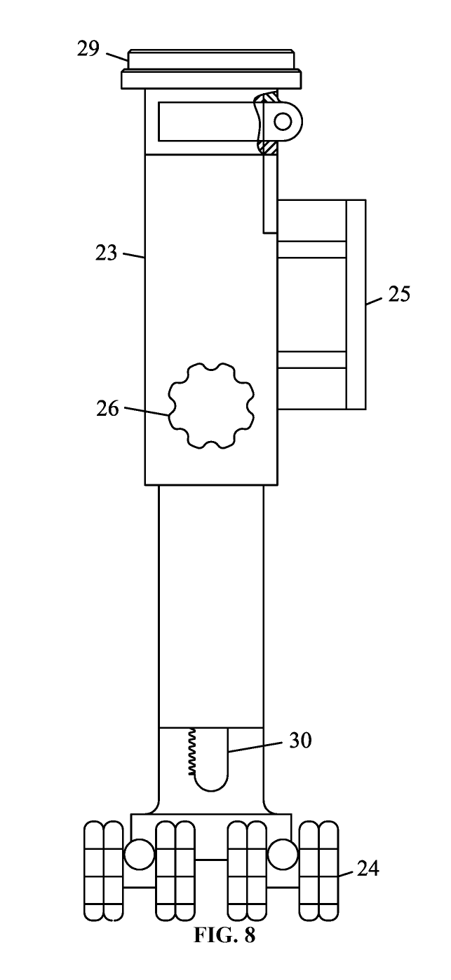

Referring to FIGS. 5-8, the measuring unit comprises a first support frame 21, a second support frame 22 and a third support frame 23. The second support frame 22 and the third support frame 23 are vertically connected to two ends of the first support frame 21. The second support frame 22 is in slide connection to one end of the first support frame 21, and the third support frame 23 is in slide connection to the other end of the first support frame 21. A self-balancing universal wheel assembly 24 is connected to the bottom of each of the second support frame 22 and the third support frame 23. An angle measuring instrument 25 used for measuring an angle of scoliosis is mounted on the first support frame 21. In use, the second support frame 22 and the third support frame 23 are in close contact with the body by adjusting the self-balancing universal wheel assembly 24. Meanwhile, the second support frame 22 and the third support frame 23 can move along the first support frame 21 to adjust the distance between the second support frame 22 and the third support frame 23, to measure different parts of the body. The angle measuring instrument 25 is adapted to read an angle of inclination of the first support frame 21, i.e., the scoliosis and body angle of trainees in the dancing training process. The angle measuring instrument is an angle meter, preferably a bi-directional angle meter. A scale line indicative of the distance is provided on each of the first support frame 21, the second support frame 22 and the third support frame. Preferably, the first support frame 21, the second support frame 22 and the third support frame are an upper support plate, a first support plate and a second support plate, facilitating the use thereof. By use of the dance training device as described in the disclosure, the scoliosis angle of the spine can be detected quickly and accurately. This is helpful for early detection, diagnosis and treatment to ensure the physical and psychological health of children.

The top end of the second support frame 22 and the top end of the third support frame 23 are both sleeved on the first support frame 21. A steel ball spring pin 27, which is fitted with the first support frame 21, is provided on each of the second support frame 22 and the third support frame 23. The second support frame 22 and the third support frame 23 are capable of sliding from one end to the other or vice versa along the first support frame 21 or are fixed on the first support frame 21 through the steel ball spring pins 27. The second support frame 22 and the third support frame 23 each are provided with a threaded hole, and the steel ball spring pins 27 are screwed into the threaded holes to fix the second support frame 22 and the third support frame 23 on the first support frame 21.

By adjusting the steel ball spring pins 27, the distance between the second support frame 22 and the third support frame 23 is adjusted to match different parts of the body of the trainees. By screwing the steel ball spring pins 27 out of the threaded holes, the second support frame 22 and the third support frame 23 can be moved, and by screwing the steel ball spring pins 27 in the threaded holes so that the front ends of the steel ball spring pins 27 butts against the first support frame 21, the second support frame 22 and the third support frame 23 are fixed.

Both the second support frame 22 and the third support frame 23 are telescopic support frames. Each of the telescopic support frames comprises a sleeve plate connected to the first support frame 21 and a liner plate having an end spliced into the sleeve plate. The other end of the liner plate is connected to the self-balancing universal wheel assembly 24. Preferably, the telescopic support frames are telescopic support plates. By adjusting the length of the liner plate spliced into the sleeve plate, the height of the second support frame 22 and the third support frame 23 can be adjusted, thus widening the application range of the device.

A lateral sliding gear 26 fitted with the liner plate is provided on the sleeve plate and a lateral sliding groove 30 fitted with the lateral sliding gear 26 is formed on the liner plate. A lateral rack engaged with the lateral sliding gear 26 is provided in the lateral sliding groove 30. The liner plate slides from top to bottom or from bottom to top along the sleeve plate under the cooperation of the lateral sliding gear 26 with the lateral rack. A control handwheel adapted to adjust the rotation of the lateral sliding gear 26 is connected to the lateral sliding gear. The rotation of the lateral sliding gear 26 drives the liner plate to move from top to bottom or from bottom to top relative to the sleeve plate, in order to adjust the height of the second support frame 22 and the third support frame 23. The arrangement of the control handwheel facilitates the adjustment of the lateral sliding gear 26.

A scale is formed on each of the first support frame 21, the liner plate of the second support frame 22, and the liner plate of the third support frame 23. By the arrangement of the scale, the adjustment of the second support frame 22 and the third support frame 23 is convenient and accurate.

The self-balancing universal wheel assembly 24 comprises two groups of universal wheels connected to a transverse connecting shaft. Each group of universal wheels comprises four roller wheels 28 connected to the transverse connecting shaft by a connecting rod. The four roller wheels 28 are connected to four corners of the connecting rod via two longitudinal connecting shafts. A limiting block is provided on the transverse connecting shaft, a limiting groove is formed on the connecting rod, and the connecting rod is mounted on the transverse connecting shaft by the fitting of the limiting groove with the limiting block. A swinging groove is formed on the longitudinal connecting shaft, a swinging block is provided on the connecting rod, and the longitudinal connecting shaft is mounted on the connecting rod by the fitting of the swinging groove with the swinging block. The two roller wheels 28 connected to a longitudinal connecting shaft can swing back and forth, and the eight roller wheels 28 connected to a same transverse connecting shaft can swing side to side. Such an arrangement is convenient for matching the accidented body surface in order to implement angle measurement on various parts of the body. A limiting block is provided on the transverse connecting shaft, a limiting groove is formed on the connecting rod, and the connecting rod is mounted on the transverse connecting shaft by the fitting of the limiting groove with the limiting block. A swinging groove is formed on the longitudinal connecting shaft, a swinging block is provided on the connecting rod, and the longitudinal connecting shaft is mounted on the connecting rod by the fitting of the swinging groove with the swinging block. In this way, the connecting rod can swing about the transverse connecting shaft just by a certain angle, and the longitudinal connecting shaft can swing about the connecting rod just by a certain angle. Furthermore, the limiting groove is slightly larger than the limiting block and the swinging groove is slightly larger than the swinging block, so that the roller wheels cannot swing by 360 degrees. Thus, each of the roller wheels 28 is somewhat limited. Meanwhile, the roller wheels 28 can rotate about the longitudinal connecting shaft, so that the angle measuring instrument can measure the scoliosis and body angle more quickly and accurately.

The angle measuring instrument is mounted in the middle portion of the first support frame 21 by a rotating shaft to obtain a reading in a vertical or horizontal direction. The angle measuring instrument may be rotated about the first support frame 21 by a rotating shaft to be vertical or parallel to the first support frame 21, in order to measure data in the vertical or horizontal direction. Furthermore, when not in use, the angle measuring instrument may be folded below the first support frame 21, which is convenient for carrying and storage.

A universal bubble level 29 is provided on the top of each of the second support frame 22 and the third support frame 23. With the arrangement of the universal bubble level 29, it can be more intuitively indicated whether the measuring instrument is in an absolute level. This is convenient for the use of the measuring instrument.

An external computer, which is provided for subsequently processing and printing the measured information, is connected to the angle measuring instrument. The external computer is connected to the angle measuring instrument via USB or wireless Bluetooth, to receive data information measured by the angle measuring instrument, post-process the data information, and print various detection data reports by a printer.

The angle measuring instrument may be an angle meter disclosed in the related art, preferably an induction display connected to a microcomputer. The induction display comprises a host, a display screen, a lithium battery and a charger. The host comprises a sensor which is of a polycrystalline structure formed by surface-micromachining on the top of a silicon wafer. A polycrystalline spring structure is suspended over the surface of the silicon wafer and provides a resistance force against the accelerating force. The deflection measurement of this structure is implemented by an independent fixed plate and a connecting plate. The fixed plate is driven by phase square wave. The acceleration will result in imbalance in the differential capacitor on the beam. As a result, the amplitude of the output square wave is in direct proportion to the acceleration. Then, signals are corrected by phase sensitive demodulation and the direction of the acceleration is determined. In this way, a relative or absolute level angle is measured.

The usages and functions of the training unit of the dance training device described in the disclosure will be described below in details in comparison with conventional training devices.

1. Comparison in Shoulder Training

The conventional shoulder training method is to stretch the shoulders by an external force. This may result in antagonistic damage.

In the embodiment, the shoulders are stretched by the dancer's body strength in the presence of the buffering action and reaction provided by the airbag.

2. Comparison in Waist Training

The conventional method for stretching the lumbar segment by pressing lead to above 80% professional dancers suffering different degrees of damage to their waist.

In the embodiment, the stretching and warm-up training of the thoracic segment and the lumbar segment is realized by the dancer's body strength and in virtue of the buffer action and reaction provided by the self-balancing airbag. Various damages caused by the conventional method for stretching the thoracic segment and the lumbar segment by pressing are avoided.

3. Comparison in Leg Training

Conventionally, the legs are stretched by an external force or on a bar. For most trainees, their legs have asymmetric stretching. It is likely to suffer pain and discomfort when stretching the side of the body with poor stretching. Over time, scoliosis will be caused. The application of a stress to the body may result in deformation of the legs and permanent injury to the meniscus of children.

In the embodiment, elastically stretching the legs vertically to the ground completely avoids asymmetric training, scoliosis, and formation of big knees or knee hyperextension.

4. Comparison in Crotch Training

Conventionally, the crotch training is implemented by stretching, pressing, ripping and pulling. The pain and damage are obvious. Moreover, the deformation of bones of children may be caused.

In the embodiment, by using the self-balancing airbag below the crotch, the core muscles of dancers can be stretched in an isometric manner. Meanwhile, the crotch is stretched by the dynamic interaction of the agonistic muscles and antagonistic muscles in the legs. In this way, the stretching training of the crotch joint is realized. Injuries caused by stretching, pressing, ripping and pulling are completely avoided.

5. Comparison in Somersault Training

The conventional somersault training method may result in accidents such as lumbar sprain, rushing forward, and falling backward.

In the embodiment, based on the principle of geometrical mechanics, the buffer action and reaction provided by the self-balancing airbag heightens the center of gravity of trainees, thereby preventing the trainees from getting injured when hitting the ground.

The use principle and functions of the measuring unit of the dance training device as described in the disclosure will be further described below.

I. The Measurement of Scoliosis of the Trainees

The measuring unit can quickly detect and diagnose abnormalities in functional planes of the body, which are caused by scoliosis and various damages, for example, a vertical angle at which head and neck are off the coronal plane, a vertical angle at which head and shoulders are off the sagittal plate, a horizontal angle of shoulders, a horizontal rotation angle of should blades, a horizontal rotation angle of back, a horizontal rotation angle of crotch, and a horizontal angle of feet, according to the physiological properties of a normal spine and the physiological properties of a spine with scoliosis. The detection results of the body parts, with accuracy up to 0.01-0.05 degrees, can be obtained within several seconds.

II. The Application of Rehabilitation Training for Neck-Shoulder Pain and Lumbocrural Pain

According to the physiological property that muscles on both sides of the spine are symmetric, when muscle injury and pain on one side results in the contraction of muscles, the functional planes of the body may be not symmetric anymore. By the measuring unit, such a change is detected, compared and diagnosed. It is the strong guarantee for pathologic analysis and rehabilitation training for neck-shoulder pain and lumbocrural pain.

III. The application of body and limbs balance training for DanceSport

During the training for DanceSport, the training is monitored by the training device. Various body and injury problems caused by blind training are completely avoided.

The self-balancing universal wheel assemblies can move freely, which benefits the close contact of the body of the trainees with the training unit.

The dance training device can employ high-accuracy polymer cells, large-screen LCDs, buzzer alarms, single-axis/two-axis mode, and is widely applied in the fields such as medical treatment, dance and fitness, machine manufacturing, professional construction and instrument examination, with advantages of quick detection, quick response and automatic correction. Moreover, it can perform data transmission with a computer via a USB interface or wireless Bluetooth so that the data is post-processed by the computer. Various detection data reports can be directly printed by a printer connected thereto.

It will be obvious to those skilled in the art that changes and modifications may be made, and therefore, the aim in the appended claims is to cover all such changes and modifications.

What is claimed is:

1. A dance training device, comprising:
a training unit;
a measuring unit; and
a connection rod;
wherein:
the training unit is connected to the measuring unit via the connection rod;
the training unit comprises a base, an elastic balancing plate, and a self-balancing airbag disposed between the elastic balancing plate and the base;
one end of the base is connected to one end of the elastic balancing plate using a rotary joint;
the base comprises an upper surface and a balancing trough disposed on the upper surface, and the self-balancing airbag is located in the balancing trough;
the measuring unit comprises a first support frame, a second support frame, a third support frame, self-balancing universal wheel assemblies, and an angle measurement instrument;
the second support frame and the third support frame are vertically disposed relative to the ground, and each comprises a first end and a second end;
two ends of the first support frame are joined to the first ends of the second support frame and the third support frame, respectively, and the self-balancing universal wheel assemblies are disposed on the second ends of the second support frame and the third support frame, respectively;
the angle measurement instrument is rotatably disposed on the first support frame; and
the first support frame, the second support frame, and the third support frame each are provided with a scale, and the second support frame and the third support frame each comprise a top surface and a bubble level disposed on the top surface.

2. The device of claim 1, wherein the training unit further comprises a support roller which is adapted to roll on the elastic balancing plate; two ends of the support roller are provided with support mechanisms and rolling wheels, respectively, and the rolling wheels are respectively disposed in the support mechanisms; two sides of the elastic balancing plate are provided with sliding rails, and the rolling wheels are adapted to roll on the sliding rails.

3. The device of claim 2, wherein the rolling wheels employ three mutually meshed gears, and one of the three mutually meshed gears is provided with a control handwheel.

4. The device of claim 1, wherein two self-balancing airbags and four balancing troughs are employed; every two balancing troughs are arranged side by side, and are adapted to accommodate one of the two self-balancing airbags.

5. The device of claim 1, wherein the training unit further comprises a placement plate; the placement plate is disposed at one side of the balancing trough and comprises an auxiliary groove and a fastener adapted to fasten the balancing trough and the placement plate, and the self-balancing airbag is located in the balancing trough and the auxiliary groove of the placement plate.

6. The device of claim 1, wherein the base is connected to the elastic balancing plate through a rotary mechanism; the rotary mechanism comprises a rotating shaft and shaft seats; the rotating shaft runs through the one end of the elastic balancing plate; the shaft seats are fixed on the base, and two ends of the rotating shaft are supported by the shaft seats.

7. The device of claim 1, wherein the elastic balancing plate comprises an outer surface and a recess formed on the outer surface; and a buffer cushion is disposed in the recess.

8. The device of claim 1, wherein the elastic balancing plate is arc-shaped.

9. The device of claim 1, wherein the second support frame and the third support frame are telescopic.

10. The device of claim 9, wherein the second support frame and the third support frame each comprise a sleeve plate and a liner plate; the second support frame and the third support frame are connected to the first support frame via sleeve plates; one end of the liner plate is inserted in the sleeve plate, and the other end of the liner plate is connected to one of the self-balancing universal wheel assemblies.

11. The device of claim 10, wherein the sleeve plate comprises a lateral sliding gear, and the liner plate comprises a lateral sliding groove corresponding to the lateral sliding gear; and the lateral sliding gear is provided with a control handwheel.

12. The device of claim 10, wherein the sleeve plates of the second support frame and the third support frame are provided with spring pins, and the two ends of the first support frame are joined to the second support frame and the third support frame via the spring pins of the sleeve plates, respectively.

13. The device of claim 1, wherein the self-balancing universal wheel assemblies each comprises a transverse connecting shaft and two universal wheelsets disposed on the transverse connecting shaft; each universal wheelset comprises four roller wheels connected to the transverse connecting shaft through a connecting rod; the four roller wheels are connected to four corners of the connecting rod through two longitudinal connecting shafts; the transverse connecting shaft comprises a limiting block, the connecting rod comprises a limiting groove corresponding to the limiting block, and the connecting rod is mounted on the transverse connecting shaft via the limiting groove and the limiting block; the two longitudinal connecting shafts each comprise a swinging groove, the connecting rod comprises a swing block corresponding to the swing groove, and the two longitudinal connecting shafts are mounted on the connecting rod via the swing block and the swing groove.

14. The device of claim 1, wherein the angle measurement instrument is an induction display connected to a microcomputer.

15. The device of claim 14, wherein the induction display comprises a host, a display screen, a lithium battery, and a charger; and the host comprises a sensor which is of a polycrystalline structure.

16. The device of claim 1, wherein a plurality of support pads is distributed on a bottom surface of the base.
